(19) United States
(12) Patent Application Publication
(10) Pub. No.: US 2003/0015469 A1
(43) Pub. Date: Jan. 23, 2003

(54) Modified intermittent cycle, extended aeration system (miceas)

(76) Inventors: Michael David Hedenland, Grass Valley, CA (US); Lloyd Duane Hedenland SR., Grass Valley, CA (US); Mark D. Hedenland, Grass Valley, CA (US)

Correspondence Address: Michael D. Hedenland, 431 Crown Point Circle, Suite C, Grass Valley, CA, 95945, US

(21) Appl. No.: 10/125,093

(22) Filed: Apr. 17, 2002

Related U.S. Application Data
(60) Provisional application No. 60/284,654, filed on Apr. 17, 2001.

(51) Int. Cl. C02F 3/02

(52) U.S. Cl. 210/620

(57) ABSTRACT

A semi batch biological waste treatment process used to treat municipal and industrial wastes containing BOD, nitrogen and phosphorous. The process uses two biological reactors in series, with each maintaining a mixed liquor inventory. Inputs and outputs from the reactor series are performed through the addition and removal of small batches. The reactors can be configured in multiple ways for different waste conditions. The preferred embodiment is an integrated batch process that includes an anoxic equalization vessel, an aerobic biological reactor, a clarification step with denitrification, a tertiary effluent treatment phase with ozone injection and filtration and an automatic sludge wasting method with thickening and stabilization. The process has two denitrification phases and has very high nitrogen removal rates.

### CROSS-REFERENCE TO RELATED APPLICATIONS:

This application claims benefit of U.S. Provisional Application Ser. No. 60/284.654 filed Apr. 17, 2001, and is incorporated herein by reference.

### STATEMENT REGARDING FEDERAL SPONSORED RESEARCH AND DEVELOPMENT:

There are no rights to the invention by virtue of any federally sponsored research and development.

### U.S. Classifications

210/602; 210/620; 210/195; 210/252

### International Class

C02F 003/02

### Field of Search 210/602; 210/613; 210/620; 210/621; 210/622; 210/623; 210/89; 210/142; 210/513

References Cited

| | | |
|---|---|---|
| 5,736,047 | April 1998 | Ngo |
| 6,190,554 | February 2001 | Mandt |
| 5,205,936 | April 1993 | Topnik |
| 5,601,719 | February 1997 | Hawkins |
| 5,744,041 | April 1998 | Grove |
| 5,552,523 | June 1982 | Ho, et al |
| 6,361,698 | June 1999 | Ti |
| 5,078,882 | January 1992 | Northrup |
| 5,972,219 | October 1999 | Habets |

### BACKGROUND OF THE INVENTION:

1. Technical Field

The proposed invention relates to the field of biological treatment of wastewater for the removal of BOD, nutrients and TSS specifically using a semi-batch, multi-vessel, activated sludge system.

2. Background of Invention

Historically municipal waste treatment processes have been the flow through type primarily because they are easy to operate. These processes mainly were concerned with BOD removal. There are some inherent problems with this type of design especially if nitrogen removal is desired. One of the problems with a flow through aeration bioreactor is that the entire reactor runs at the Food to Mass ratio of the exiting conditions, which isn't the optimal condition for rapid BOD removal. When these types of systems are run so that nitrification occurs, often there are problems with the down stream clarifier when denitrification occurs and floats the flock. Batch systems get around some of these problems because the individual stages of the treatment process are carried out in discrete batches and are much easier to regulate, control and configure the biological and physical processes. In the past, the sequencing and timing of the various batch functions required complicated relay and timer logic that was bulky and often unreliable. With the advent of inexpensive solid state Programmable Logic Controllers most of these problems have been eliminated.

There are many versions of the Sequencing Batch Reactor (SBR) in use. With these systems each phase of the treatment process is carried out in a single vessel or reactor. There is a fill phase, an anoxic phase, an aeration phase and a settling phase. Each stage of the process must be completed prior to moving to the next. The single reactor has to effectively function as different types of equipment. Also to get a high level of nitrogen removal in the effluent requires that a large amount of the clarified liquid to be left in the reactor for the next batch. This greatly increases the size of the system for a specific flow rate.

The treatment system presented is a batch process but with separate equipment for the individual processes. With this approach the individual processes can occur simultaneously but in a batch type mode. This may seem like a more complicated process because the individual simultaneous processes must be staged and sequenced as an integrated and interrelated operation. This is really not a problem because defining the batch size and sizing the equipment to account for the different times of the processes, much of the complexity is eliminated. The proposed process utilizes two bioreactors in series. Each reactor maintains an inventory of mixed liquor to which the inlet and outlet flows are conducted through small batches in and out of the reactors over a period of time. The reactors can be configured to operate in specific biological modes and even cycle between modes during individual batches. The novelty of the process is evidenced by its' performance. The BOD removal rate and the nitrogen removal rate are better than any of the commercially available systems rigorously reviewed. The process can be built and operated competitively with most systems. The novelty is in the manner the equipment is sized, how the semi-batch two-bioreactor system is used, the two-denitrification steps and the control and monitoring methods used.

### SUMMARY OF THE INVENTION

The present invention is a method for treating sewage type wastes. The process includes a two-bioreactor system with a continuously held mixed liquor inventory in each reactor. Inputs and outputs of the bioreactors are performed with the addition and removal of small batches to the mixed liquor inventories. The additional processes are batch processes that include; clarification, tertiary effluent treating, two distinct phases of denitrification, activated sludge return and a solids wasting method with thickening and stabilization. The process describes the sizing of equipment, the batching size and frequency, the method of control of the integrated batch system, a method to optimize the separation/denitrification phase using optical sensors and a semi-batch, semi-continuous method for disinfection and TSS removal through ozone injection and filtration. Different reactor, batch, and recycle configuration are also detailed for the process. The preferred embodiment meets the stringent California Title 22 requirements.

### BRIEF DESCRIPTION OF DRAWING:

FIG. 1 is a block process flow diagram illustrating the preferred embodiment of the present invention and indicating the line and equipment numbers referenced in the detailed process description.

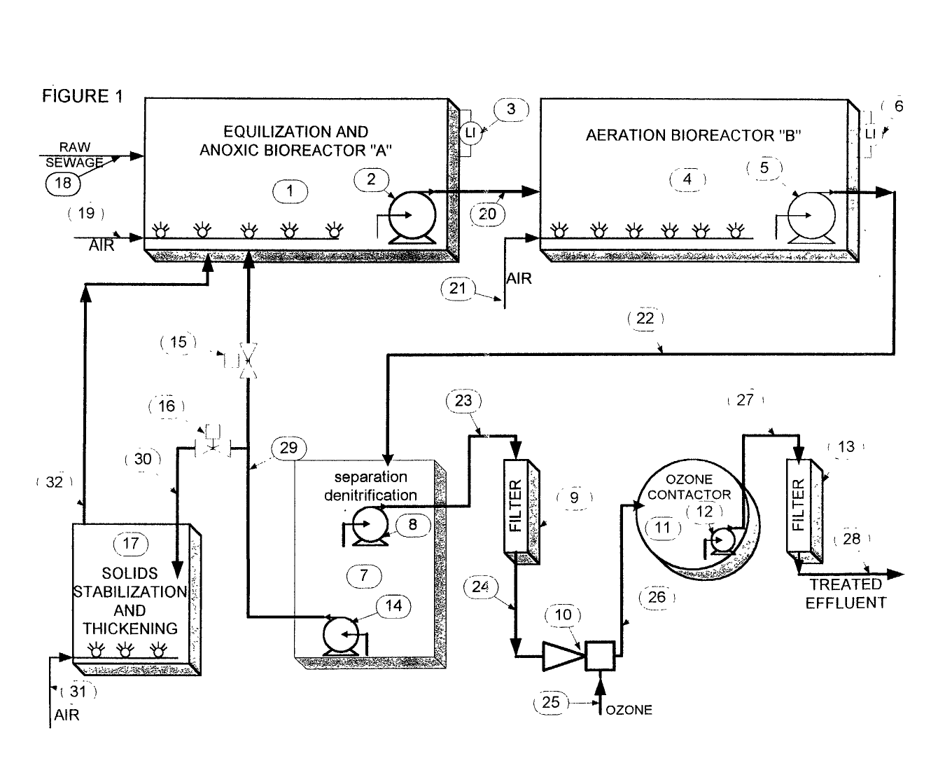

FIG. 2 is a process flow diagram illustrating a batch control method for the settling denitrification vessel based on optical detectors.

### DETAILED DESCRIPTION:

Raw sewage 18 is introduced into the equalization and anoxic bioreactor 1. The size of this reactor is approximately 30% of the total daily sewage volume. This reactor is used to normalize the loading to the remainder of the process and supplies the anoxic environment for further denitrification of the return stream 29 from the separation/denitrification vessel 7. The equalization and anoxic bioreactor1 is agitated through periodic minimal air sparging 19. A minimum 50% volume is maintained bioreactor 1. The anoxic conditions and the carbon source supplied by the raw sewage, any nitrates not converted to nitrogen in the separation/denitrification vessel 7 will be converted by the aerobic heterotrophic bacteria maintained in the mixed liquor residing in the equalization and anoxic bioreactor 1. Depending on the level measured by level indicator 3, the PLC control system automatically starts pump 2 and pumps a portion of reactor 1 to the aeration bioreactor 4 through line 20. The transfer will automatically hold until the level and batch stage of the aeration bioreactor 4 is ready to accept the batch.

For normal domestic sewage concentrations, aeration bioreactor 4 is sized at 75% of the total daily sewage flow. This reactor maintains an average 65% volume of mixed liquor active biological culture to treat the incoming batch of waste. Dissolved oxygen concentration is maintained above 1.5 ppm with aeration air 21. Total air supplied is set at 125% of the amount calculated from the standard equations for oxidation of BOD and ammonia. With normal domestic sewage concentrations, the mixed liquor suspended solids are held between 3000 ppm and 6000 ppm. When level indicator 6 goes above approximately 85% and the separation/denitrification vessel 7 is empty the PLC activates pump 5 and fills vessel 7 via line 22. The batch volume pumped out is approximately 33% of the aeration reactor volume or 24% of the total daily sewage volume.

The separation/denitrification vessel 7 is sized at approximately 33% of the total volume of the aeration bioreactor 4. After the mixed liquor is transferred to the separator the suspended solids are allowed to settle. The PLC activates pump 8 to pump out the top 33% of the separator volume via line 23. The volume pumped out is automatically set by the location of the pump 8 in the separator vessel.

Although this is the clear liquid fraction, stream 23 is filtered in a dual backwashing filter 9 or through some other type of self-cleaning filter to remove any suspended solids that would impart additional chemical oxygen demand to the solution. The filtered solution 24 is then contacted with ozone 25 in venturi 10. After ozone injection the batch flows to the ozone contactor 11 where contact time is provided for proper disinfection. The ozone contactor 11 is sized to hold the entire top 33% of the separation vessel 7. The ozone is injected at a rate sufficient to hold a residual ozone concentration for disinfection(approximately 1 to 3 ppm) in the liquid for approximately 3 minutes. During start-up or upset conditions the ozone contactor volume can be recirculated through the venturi for additional ozone contact.

Disinfected effluent in the ozone contactor 11 is discharged via pump 12 through line 27 to the final filter 13. The final filter can be the multiple back washable type or one of the many self cleaning type available. The final filter removes any precipitated or coagulated suspended solids resulting from the ozone addition. The treated effluent leaves the process via stream 28. Treated effluent can then be used for unrestricted water reuse in accordance California Title 22. After the effluent is pumped out of the top of the separation/denitrification vessel 7, the remaining 66% is allowed to go anoxic for denitrification. This is evidenced by the floating of the settled sludge layer due to entrapment of nitrogen gas. After this phase of denitrification, pump 14 is activated, valve 15 is opened and the entire volume of solids and liquids are returned to the equalization and anoxic bioreactor 1 via line 29. Additional denitrification can now occur due to the available carbon source from the incoming raw sewage.

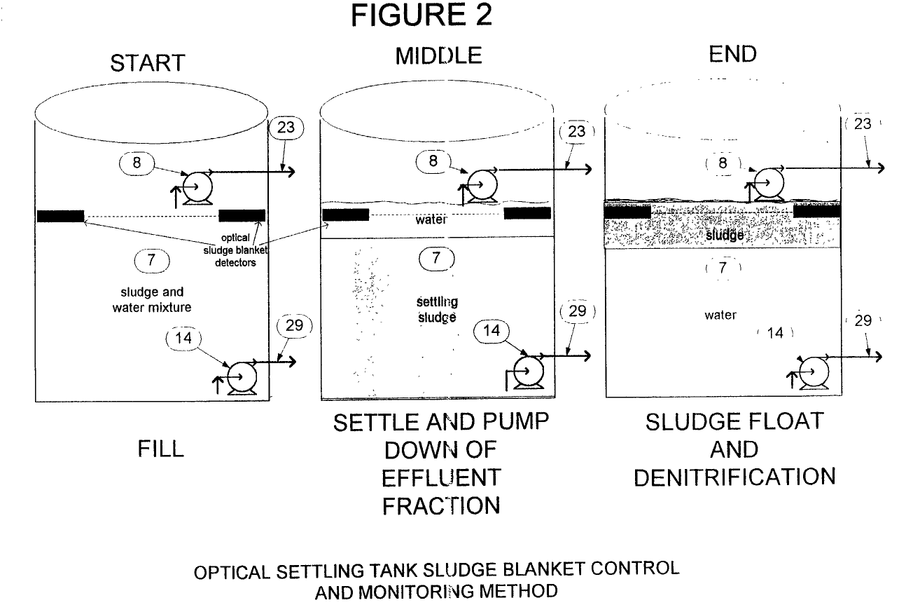

FIG. 2 shows an alternative method for controlling the operation of the separation/denitrification vessel 7. Instead of fixed time intervals allotted for settling solids and subsequent floating of the solids executed by the PLC, an optical sludge blanket control method can be used. By actually monitoring the location of the sludge blanket, batch times can be reduced or conversely incomplete batches can be prevented from being pumped out. At the start, mixed liquor from the aeration bioreactor 4 is pumped over to fill the separation/denitrification vessel 7. When the optical sludge blanket detectors indicate the sludge blanket has settled past the suction level of pump 8 the effluent batch can be pumped out for filtering and disinfection. This is shown as the middle phase on FIG. 2. In the end phase the optical detectors indicate when the sludge blanket floats up from the bottom during denitrification.

Solids wasting from the integrated process is accomplished by diverting some of the return stream 29 to the solids stabilization and thickening vessel 17 through line 30 by closing valve 15 and opening valve 16. The frequency and duration of the wastings of biomass are entered into the PLC by the operator. Adjustments to the automatic wasting rate are based on periodic MLSS (mixed liquor suspended solids) measurements of the aeration bioreactor 4. Prior to the wasting event, the aeration air 31 is turned off and the solids are allowed to settle. As the new slurry is added to the vessel 17 during wasting, clear liquid is overflowed back to the equalization vessel 1, resulting in a thickening of the sludge contained in vessel 17.

1. A Biological treatment process for the removal of BOD and nutrients form domestic, industrial and animal wastes, centering around two bioreactors system in series where:
a. Each reactor maintains a mixed liquor inventory,
b. Feed to and from the reactors is in the form of small batches added to and removed from the mixed liquor inventories,
c. Each reactor can be configured to operate in an anoxic mode, an aerobic mode or cycled between,
d. Each reactor can be configured to discharge a mixed liquor batch or a clear supernatant by settling prior to discharge, and,
e. Each reactor can be configured along with return streams to segregate the biomass solids of each reactor in order to facilitate specific biological activities through different distribution of organisms.

2. A totally integrated, semi-batch, intermittent cycle wastewater treatment process that includes all or part of the following:
a. An equalization and anoxic bioreactor vessel that:
i. Accepts incoming raw waste,
ii. Maintains a mixed liquor inventory
iii. Accepts return stream from a separation/denitrification process that includes mixed liquor solids remaining clarified after effluent portion is pumped out, and,
iv. Discharges batch from the contained mixed liquor inventory to the aeration bioreactor
b. An aerobic vessel that:
i. Accepts mixed liquor batch from the equalization/anoxic bioreactor,
ii. Maintains a mixed liquor inventory, and,
iii. Discharges mixed liquor batch to the separation/denitrification vessel.
c. A separation denitrification vessel that;
i. Accepts batch of mixed liquor from the aeration bioreactor,
ii. Allows for settling of the mixed liquor solids,
iii. Pumps out a portion of the clarified liquid to be processed as effluent
iv. Can allow the remaining mixture to denitrify by going anoxic, and,
v. Returns the remaining mixture to the equalization/anoxic bioreactor.
d. An effluent disinfection and filtering process that;
i. Uses ozone for disinfection, and,
ii. Uses filtration for total suspended solids removal.
e. A solids stabilization/thickening apparatus and process that:
i. Accepts periodic wasting of the biomass from the process, and,
ii. Allows periodic settling of the contained biomass slurry to return clarified liquids to the equalization vessel.

3. A process according to claim 2 where the equalization/anoxic bioreactor is cycled between anoxic and aerobic conditions.

4. A process according to claim 2 where the equalization/anoxic bioreactor is operated in an aerobic condition.

5. A process according to claim 2 where the batch transferred from the equalization bioreactor only contains clarified liquids.

6. A process according to claim 2 where disinfection is performed with ozone Ultraviolet light, Chlorine or heat.

7. A PLC based method to automatically operate the integrated waste treatment processes and apparatus that encompasses any or all of the following functions:
a. Sequences and sets time intervals of all the related batch functions of the integrated process,
b. Monitors the correct completion of the intergraded batch processes through; confirmation of expected level increases or decreases between batches, monitoring current draws for the various pumps, detection of high or low level conditions, detects any out f range conditions for any pH, ORP, turbidity, Opacity and temperature control or indicating devises installed on the process,
c. Configures the integrated processes for start up, shut down, idle and manual mode,
d. Monitors and logs pertinent information for regulatory agency reporting,
e. Provides a HMI (human machine interface) for the adjustment of the non protected and protected program variables like batch size, mixed liquor inventories, wasting rate and frequency, alarm set points and acknowledgement, process timers, and liquid level set points, and,
f. Reacts to various alarm or upset conditions with predetermined mitigating procedures.

8. A method for the monitoring sludge blanket positions using optical indicators in the separation vessel to optimize the sludge settling operation and subsequent denitrification operation.

9. A method for effluent disinfection and filtering to reduce ozone consumption and total suspended solids comprising of:
a. Filtering the biological treated effluent to remove solids with chemical oxygen demand,
b. Injecting ozone in-line at a rate to hold a residual disinfecting concentration for the specific application for a minimum of three minute in the filter feed going to the contactor vessel,
c. Providing contactor storage vessel to allow adequate contact time of the injected ozone and to allow the precipitation or coagulation of solids resulting from the ozone addition, and,
d. Filtering the disinfected effluent prior to final discharge for removal of suspended solids.
